(19) United States
(12) Patent Application Publication
(10) Pub. No.: US 2022/0171622 A1
(43) Pub. Date: Jun. 2, 2022

(54) MULTI-DIMENSION DMA CONTROLLER AND COMPUTER SYSTEM INCLUDING THE SAME

(71) Applicant: Electronics and Telecommuunications Research Institute, Daejeon (KR)

(72) Inventors: JOO HYUN LEE, Daejeon (KR); Jin Ho HAN, Seoul (KR)

(73) Assignee: Electronics and Telecommunications Research Institute, Daejeon (KR)

(21) Appl. No.: 17/533,891

(22) Filed: Nov. 23, 2021

(30) Foreign Application Priority Data
Nov. 27, 2020 (KR) 10-2020-0161870
Mar. 31, 2021 (KR) 10-2021-0041598

(51) Int. Cl. G06F 9/30; G06F 12/0831; G06F 7/575

(52) U.S. Cl. CPC G06F 9/3004; G06F 7/575; G06F 12/0835; G06F 9/30101

(57) ABSTRACT

Disclosed is a multi-dimension DMA controller for performing a direct memory access (DMA) of multi-dimension data stored in a memory, according to the present disclosure, which includes a descriptor including a microcode descriptor, a normal descriptor, and a three-dimensional blob descriptor for accessing the multi-dimension data, a microcode controller that executes an instruction included in the microcode descriptor, and a transmission controller that automatically transmits at least a portion of the multi-dimension data depending on a parameter stored in the descriptors.

### CROSS-REFERENCE TO RELATED APPLICATIONS

This application claims priority under 35 U.S.C. § 119 to Korean Patent Application Nos. 10-2020-0161870, filed on Nov. 27, 2020, and 10-2021-0041598, filed on Mar. 31, 2021, respectively, in the Korean Intellectual Property Office, the disclosures of which are incorporated by reference herein in their entireties.

### BACKGROUND

Embodiments of the present disclosure described herein relate to a computer system, and more particularly, relate to a multi-dimension direct memory access controller capable of increasing access performance of multi-dimension data, and a computer system including the same.

Direct memory access controller (hereinafter, DMAC) technology has been widely used in computer systems up to now as a technology for improving the performance of a CPU or a processor. Data set in the control register of the direct memory access controller (DMAC) is commonly referred to as a DMA descriptor. In general, the DMA descriptor includes at least four registers.

For example, the DMA descriptor may include a source address register, a destination address register, a data size register, a subsequent descriptor address register, etc.

The source address register stores a start address of data to be read from the memory. The destination address register stores a start address of the memory to which copied data is to be written. In addition, an address of the DMA descriptor to be read by the DMAC for copying subsequent data after a data copy by a current DMA descriptor is completed may be stored in the subsequent descriptor address register. In addition, the DMA descriptor may further include values (e.g., isLast, and enIRQ) defining an attribution of the DMA descriptor.

In recent years, with the development and spread of artificial intelligence (AI) technology, it is increasingly necessary to process data in a three-dimensional array (hereinafter, referred to as ‘three-dimension data’ or “3D-BLOB”) in a computer system. The 3D data is stored in a row-major or column-major method according to a computer system and a programming language. Also, as a size and a specification of the 3D data change, positions actually stored in a physical memory are all changed.

However, support for a DMAC structure or architecture for transmitting or processing three-dimension (3D) data or three-dimensional or more multi-dimension data is insufficient. Accordingly, there is an urgent need for a DMAC technology for efficiently transmitting the 3D data or more multi-dimension data.

### SUMMARY

Embodiments of the present disclosure provide a DMA controller capable of increasing performance in accessing 3D or multi-dimension data and providing an intuitive and concise DMA programming model.

According to an embodiment of the present disclosure, a multi-dimension DMA controller for performing a direct memory access (DMA) of multi-dimension data stored in a memory, includes a descriptor including a microcode descriptor, a normal descriptor, and a three-dimensional (3D) blob descriptor for accessing the multi-dimension data, a microcode controller that executes an instruction included in the microcode descriptor, and a transmission controller that automatically transmits at least a portion of the multi-dimension data depending on a parameter stored in the descriptor.

According to an embodiment, the microcode descriptor may include a plurality of command registers. An instruction may be stored in first to third command registers among the plurality of command registers, and a subsequent descriptor address may be stored in a fourth register among the plurality of command registers stores. At least one bit of the third command register may include a data type field indicating whether the multi-dimension data is a one-dimensional array or a multi-dimensional array.

According to an embodiment, the normal descriptor may include a first command register for storing a source address, a second command register for storing a destination address, and a third command register for storing the number of transmission bytes. The third command register may include a constant write (CW) field defining an attribution of the source address. When the constant write (CW) field is logical ‘1’, a field corresponding to the source address of the first command register may indicate constant data. When the constant write (CW) field is logical ‘1’, the multi-dimension DMA controller may write the constant data corresponding to the number of transmission bytes to the destination address of the memory without performing a read operation.

According to an embodiment, the 3D blob descriptor may include first to third command registers for storing payload data, and a fourth command register for storing an address of a subsequent descriptor. The third command register may include a payload type field indicating an attribution of the payload data.

According to an embodiment, when the payload type field is a first value, the payload data may define a specification of 3D data in the memory. When the payload type field is a second value, the payload data may define a position of a macro blob included in 3D data in the memory. When the payload type field is a third value, the payload data may define a size of a macro blob included in 3D data in the memory. When the payload type field is a fourth value, the payload data may correspond to data for transmitting at least one adjacent macro blob having the same specification as a previously transmitted macro blob.

According to an embodiment, the payload data may include at least one of an iteration count of the at least one adjacent macro blob, and a direction of the at least one adjacent macro blob relative to the previously transmitted macro blob within the multi-dimension data. The payload data may include a field configured to convert an address of the at least one adjacent macro blob into a multi-dimensional array or a one-dimensional array. The payload data may include a field indicating whether to generate a fixed address or a variable address. The fixed address may correspond to a case in which the source address of the descriptor is a first-in-first-out (FIFO) memory.

According to an embodiment, the microcode controller may have 32 general purpose registers and 31 instruction codes. The microcode controller may include a source register (RS) used as an input of an ALU of the microcode controller among the general registers, and a destination register (RD) for storing a processing result of the ALU.

According to an embodiment of the present disclosure, a computer system includes a central processing unit, and a memory device, and a multi-dimension DMA controller for performing a direct memory access (DMA) of multi-dimension data stored in the memory device under a control of the central processing unit, and the multi-dimension DMA controller includes a descriptor including a microcode descriptor, a normal descriptor, and a three-dimensional (3D) blob descriptor for accessing the multi-dimension data, a microcode controller that executes an instruction included in the microcode descriptor, and a transmission controller that automatically transmits at least a portion of the multi-dimension data depending on a parameter stored in the descriptor.

### BRIEF DESCRIPTION OF THE FIGURES

The above and other objects and features of the present disclosure will become apparent by describing in detail embodiments thereof with reference to the accompanying drawings.

FIG. 1 is a block diagram illustrating a computer system according to an embodiment of the present disclosure.

FIG. 2 is a diagram illustrating 3D data of FIG. 1.

FIG. 3 is a diagram illustrating a storage structure of 3D data in a memory

FIG. 4 is a block diagram illustrating a structure of a 3D DMAC (Direct Memory Access Controller) according to an embodiment of the present disclosure.

FIG. 5 is a diagram illustrating a structure of a descriptor of the present disclosure.

FIG. 6 is a diagram illustrating a structure of a microcode (uCode) descriptor of the present disclosure.

FIG. 7 is a diagram illustrating a structure of a normal descriptor of the present disclosure.

FIGS. 8A to 8E are diagrams illustrating a structure of a blob descriptor.

FIG. 9 is a block diagram illustrating a microcode (uCode) controller of FIG. 4.

FIG. 10 is a diagram illustrating an ISA (Instruction Set Architecture) of a microcode controller of the present disclosure.

FIG. 11 is a diagram schematically illustrating an address generation method according to an embodiment of the present disclosure.

### DETAILED DESCRIPTION

Hereinafter, embodiments of the present disclosure will be described clearly and in detail such that those skilled in the art may easily carry out the present disclosure.

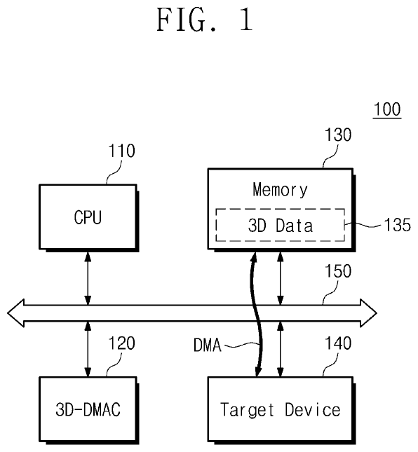

FIG. 1 is a block diagram illustrating a computer system according to an embodiment of the present disclosure. Referring to FIG. 1, a computer system 100 may include a CPU 110, a 3D DMA controller 120 that can effectively access 3D data 135, a memory 130, and a system bus 150. The computer system 100 may further include a target device 140.

The CPU 110 executes various software (e.g., an application program, an operating system, and device drivers) to be executed in the computer system 100. The CPU 110 may execute an operating system OS loaded to the memory 130. The CPU 110 may execute various application programs to be driven based on the operating system OS.

The CPU 110 may be a homogeneous multi-core processor or a heterogeneous multi-core processor. The CPU 110 may control an access of the 3D data 135 stored in the memory 130. In particular, when transmitting the 3D data 135 from the memory 130 to another external device or a system-on-chip (SoC), the CPU 110 may control the 3D DMA controller 120 such that a data transmission occurs in a direct memory access (DMA) method.

The 3D DMA controller 120 may process data transmission between the memory 130 and a target device 140 in the direct memory access (DMA) method. In detail, the 3D DMA controller 120 may access or control the memory 130 depending on a delegate of the CPU 110.

For example, the 3D DMA controller 120 may write data read from the target device 140 in the memory 130 in response to a command of the CPU 110. In this case, the 3D DMA controller 120 initially receives a transmission command from the CPU 110, but then the 3D DMA controller 120 may continuously write data in the memory 130 without intervention of the CPU 110. Alternatively, the 3D DMA controller 120 may read the 3D data 135 from the memory 130 depending on the direct memory access (DMA) method, and may transmit the read data to the target device 140.

The memory 130 may store data that are used to operate the computer system 100. The memory 130 stores or outputs data in response to a request of the CPU 110. In particular, the memory 130 may store the 3D data 135. As the development and spread of artificial intelligence (AI) technology, the recent computer system 100 is increasingly necessary to deal with data of the 3D array. The memory 130 may include a volatile/nonvolatile memory such as a static random access memory (SRAM), a dynamic RAM (DRAM), a synchronous DRAM (SDRAM), a phase-change RAM (PRAM), a ferro-electric RAM (FRAM), a magneto-resistive RAM (MRAM), and a resistive RAM (ReRAM).

The target device 140 may be a memory device or storage separate from the memory 130, or an intellectual property (IP). Alternatively, the target device 140 may be a system-on-chip (SoC) or a hardware device provided outside the computer system 100. For data transmission between the target device 140 and the memory 130, the CPU 110 may delegate a control operation to the 3D DMA controller 120. In this case, the CPU 110 may write the DMA descriptor in the register of the 3D DMA controller 120. Then, thereafter, the data requested to be transmitted may be transmitted between the target device 140 and the memory 130 under the control of the 3D DMA controller 120 without intervention of the CPU 110.

The computer system 100 described above is capable of direct memory access (DMA) with respect to the 3D (three-dimension) data 135. To this end, the computer system 100 includes the 3D DMA controller 120 capable of processing the three-dimension data 135 in the DMA method. In this case, the 3D data 135 is illustratively described, but the present disclosure is not limited thereto. That is, the present disclosure may be applied to multi-dimension data higher than the 3D data.

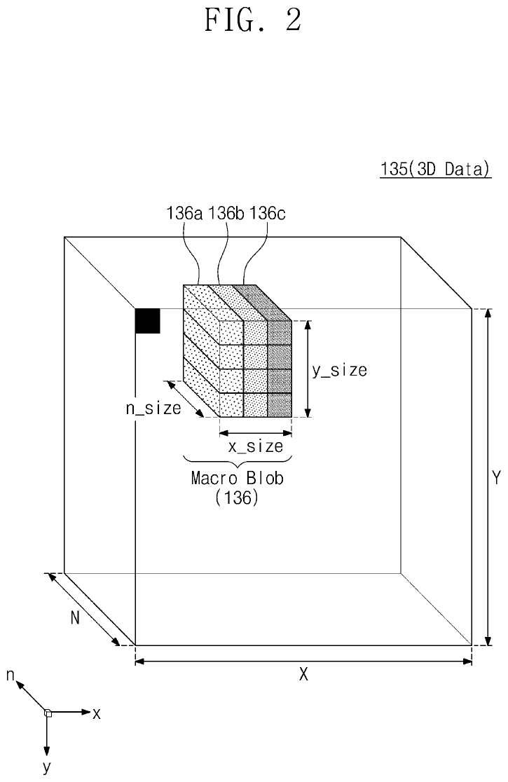

FIG. 2 is a diagram illustrating 3D data of FIG. 1. Referring to FIG. 2, the 3D data 135 is data that are generated in a multi-dimensional array or dimension when stored in the memory 130.

With the application of artificial intelligence (AI) technology, there is an increasing number of cases in which data should be arranged and transmitted in multiple dimensions to improve processing efficiency. For example, as concepts of a multi-layer perceptron (MLP) and a neural network circuit are introduced, data stored in the memory 130 are required to be stored in the form of three-dimension data 135.

The 3D data 135 (or the 3D-BLOB) may be stored in memory 130 in a Row-Major or Column-Major method according to, for example, the computer system 100 and a programming language. The Row-Major method refers to a data management method in which data are first stored in the memory 130 in a row (y) direction, then stored in the memory 130 in a column (x) direction, and then data are stored in a depth (n) direction. The column-major method refers to a method in which data are stored in the column (x) direction of the memory, then stored in the row (y) direction, and then stored in the depth (n) direction.

In addition, as the size and specification of the 3D data 135 change, the positions actually stored in the physical memory 130 may all be changed.

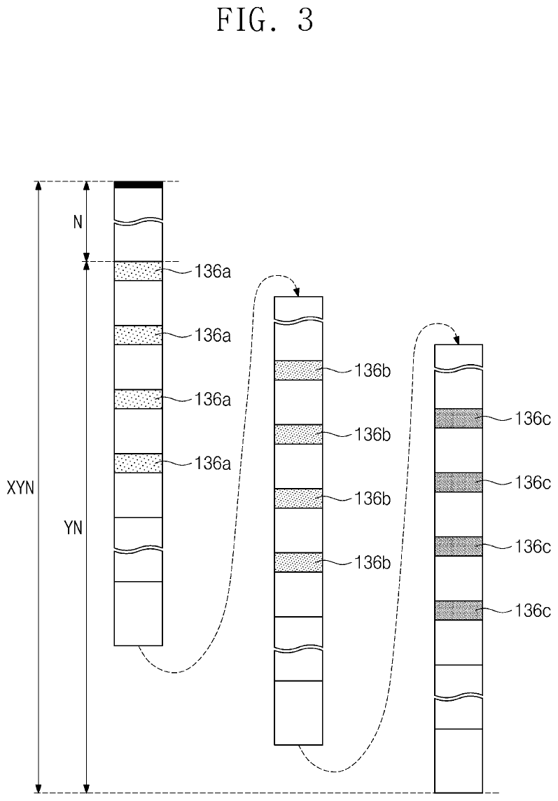

FIG. 3 is a diagram illustrating a storage structure of 3D data in a memory Referring to FIGS. 2 and 3, in the one-dimensional approach of the Row-Major method, in order for a macro blob 136 to be stored in the 3D array in the memory 130 (refer to FIG. 1), numerous descriptors should be written.

To write a portion of the 3D data illustrated as the macro blob 136 (refer to FIG. 2) in the memory 130, an arrangement of addresses in the memory 130 may be provided in the illustrated method. First, the macro blob 136 that is three-dimensionally arranged is composed of sub data 136a, 136b, and 136c allocated to different columns. When accessing the memory 130 in one dimension, the sub data 136a is discontinuously arranged even in the first column. The sub data 136b arranged in a second column different from the sub data 136a is also discontinuously arranged. The sub data 136c also have the same discontinuous arrangement as the sub data 136a and 136b. Therefore, when a general DMA control technique is applied, a large number of descriptors are required due to the discontinuous array in order to read or write data corresponding to the macro blob 136 in the 3D data 135.

That is, the existing DMAC descriptor deals with access of the one-dimensionally arranged data. Therefore, to access 3D data corresponding to the macro blob 136, a large number of 1D DMAC descriptors for accessing discontinuously displayed portions should be generated and executed.

In addition, it is necessary to always calculate the address of the macro blob according to the three-dimensional specification for each one-dimensional DMAC descriptor. Therefore, since the CPU and the software have to intervene each time, the performance of the entire system is significantly reduced, and the programming model may be very complex and complicated when developing the software. In a situation in which macro blobs should be sequentially accessed in the x-direction, y-direction, or n-direction in a three-dimensional data structure, inefficiency greatly increases.

The present disclosure proposes a format of the DMAC descriptor in which the DMA controller (DMAC) may directly process the 3D data 135 and the macro blob 136 so as to remove such inefficiency, and provides various 3D data access methods of the DMAC using the same. Through this, performance may be greatly improved in operations such as accessing the 3D data 135 or sequentially accessing the macro blob 136 inside the 3D data 135, and a very intuitive and concise DMA programming model may be provided.

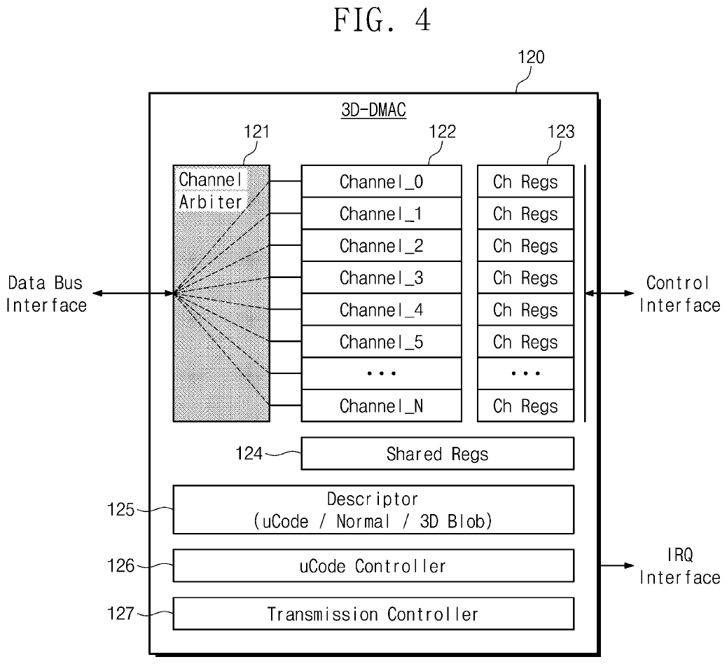

FIG. 4 is a block diagram illustrating a structure of a 3D DMAC (Direct Memory Access Controller) according to an embodiment of the present disclosure. Referring to FIG. 4, the 3D DMAC 120 may include a channel arbiter 121, a channel 122, a channel register 123, a shared register 124, a descriptor 125, a microcode (hereinafter, uCode) controller 126, and a transmission controller 127. In addition, the 3D DMAC 120 is connected to an external interface such as a data bus interface, a control interface, and an interrupt request (IRQ) interface.

The channel arbiter 121 selects a channel to which read or write data are transmitted. The channel arbiter 121 may schedule a sequence of channels or control whether use is permitted to increase the efficiency of a channel for which data transmission is requested.

The channels 122 and the channel registers 123 are set through the control interface, and are responsible for data transmission with the memory 130 or the target device 140. The shared register 124 may be provided as a means for setting an attribution shared by each of the channels.

The descriptor 125 stores and processes descriptors capable of processing the 3D data of the present disclosure. The descriptor 125 may include, for example, a uCode descriptor, a normal descriptor, and a 3D-Blob descriptor.

The uCode controller 126 performs program processing such as processing in a microprocessor by utilizing a 3D-Blob descriptor.

The transmission controller 127 controls data transmission to transmit data in various forms, sequentially, and automatically by using the 3D-Blob descriptor. The data transmission state or result may be notified to the CPU 110 (refer to FIG. 1) or the like through the IRQ interface.

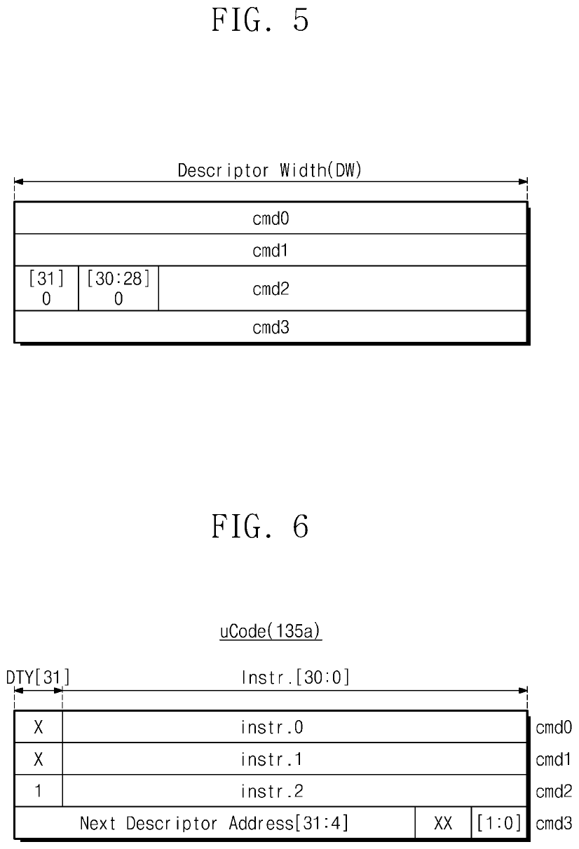

FIG. 5 is a diagram illustrating a format of a descriptor of the present disclosure. Referring to FIG. 5, the descriptor 125 of the present disclosure includes four command registers cmd0, cmd1, cmd2, and cmd3.

The bit width of each of the command registers is changed according to an address width of the computer system 100 to which the DMAC 120 is applied. For example, the bit width of each of the command registers may be 32-bit or 64-bit. In the following description, a case having a bit width of 32-bit will be described as an example.

In the case of the command register cmd2, one bit (e.g., [31]) may be set to indicate whether the corresponding descriptor is a descriptor for data movement or is a microcode (uCode) in which a plurality of instructions for the uCode controller 126 are packed. For example, when the corresponding descriptor is a descriptor provided for data movement, the [31]-th bit cmd2[31] of the command register cmd2 may be provided as logic ‘0’. In contrast, when the descriptor is microcode (uCode), the [31]-th bit cmd2[31] of the command register cmd2 may be set as logic ‘1’.

When the [31]-th bit cmd2[31] of the command register cmd2 is logical ‘0’, depending on the setting of additional predetermined register bits (e.g., cmd2[30:28]), it may be set whether the corresponding descriptor is a normal descriptor indicating one-dimensional data movement or whether the corresponding descriptor is a descriptor for setting the movement of the three-dimension data (3D blob).

For example, when the corresponding descriptor is the normal descriptor for one-dimensional data movement, register bits cmd2[30:28] may be represented by ‘0’. In contrast, when the corresponding descriptor is a 3D blob descriptor for setting 3D data movement, the register bits cmd2[30:28] may represent one of several descriptors cmd[30:28]=1, 2,3,4, and 7.

Accordingly, specific information of the corresponding descriptor may be included according to the bits cmd2[30:28] of the command register cmd2. Information included in the bits cmd2[30:28] of the command register cmd2 may be illustrated in Table 1 below. In this case, the register bit cmd2[31] may represent ‘DTY (Data Type)’, and the register bits cmd2[30:28] may represent ‘PTY (Payload Type)’.

TABLE 1

| cmd2[31] | cmd2[30:28] | Descriptor types |
|---|---|---|
| 1 | X (ignored) | uCode descriptor |
| 0 | 0 | Normal descriptor |
| 0 | 1 | (Blob) Virtual blob dimension descriptor |
| 0 | 2 | (Blob) Start index of macro blob for iteration |
| 0 | 3 | (Blob) macro blob dimension |
| 0 | 4 | (Blob) Iteration counter (1 iteration = |
| | | 1 macro blob) |
| 0 | Reserved | Reserved |
| 0 | 7 | (Blob) Blob data transfer descriptor |

In all types of descriptors, the command register cmd3 may be set to the same configuration. In detail, the command register cmd3 may include a subsequent descriptor address field of a descriptor to be loaded following the current descriptor. In addition, the command register cmd3 may include ‘isLst’ and ‘enIRQ’ fields that perform operations similar to those of the conventional DMAC technology.

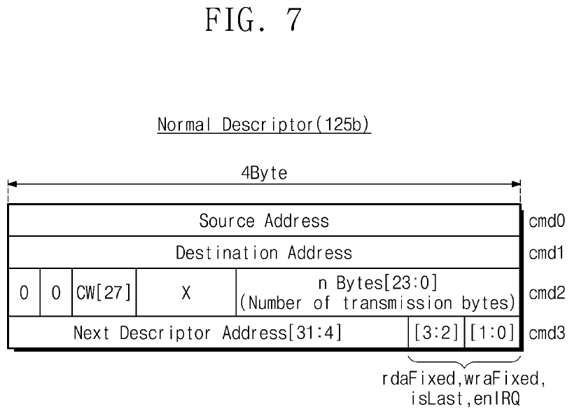

FIG. 6 is a diagram illustrating a structure of a microcode (uCode) descriptor of the present disclosure. Referring to FIG. 6, a uCode descriptor 125a may include four command registers cmd0, cmd1, cmd2, and cmd3.

The three command registers cmd0, cmd1, and cmd2 may store instructions (instr.0, instr.1, and instr.2) to be executed by the uCode controller (126, refer to FIG. 4). A register bit cmd2[31] of the command register cmd2 may be used as a field indicating ‘Data Type (DTY)’. In register bits cmd3[31:4] of the command register cmd3, an address of the following descriptor will be stored.

The uCode controller 126 includes 32 general purpose registers (GPR), and may generate a descriptor by itself by executing a program by an instruction. In addition, the uCode controller 126 may transfer the generated descriptor to internal logic of the 3D DMAC 120. Therefore, it is possible to change the data movement by the uCode controller 126 in software, variably, and dynamically according to the internal state of the system.

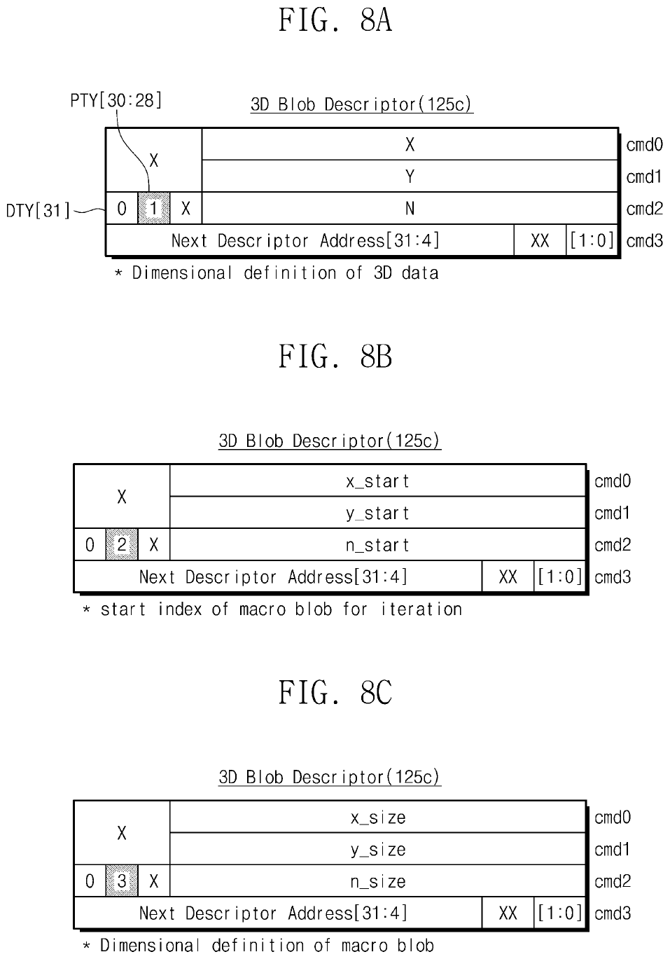

FIG. 7 is a diagram illustrating a structure of a normal descriptor defining transmission of one-dimensional data. Referring to FIG. 7, a normal descriptor 125b may include four command registers cmd0, cmd1, cmd2, and cmd3.

A source address may be set in the command register cmd0. A destination address is stored in the command register cmd1. In addition, register bits cmd2[23:0] of the command register cmd2 may include a field of the number (n Byte) of bytes to be transmitted.

In addition, the constant write (CW) field may be stored in a register bit cmd2[27] of the command register cmd2. In detail, when a bit value of the register bit cmd2[27] is set to logic ‘1’, it means that data stored in the command register cmd0 is constant data, not a source address. In this case, the 3D DMAC 120 writes constant data in a memory of n bytes starting from a destination address, and does not perform a read operation.

Register bits cmd3 [31:4] of the command register cmd3 store the address of the subsequent descriptor, and ‘rdaFixed’ and ‘wraFixed’ fields are stored in register bits cmd3[3:2]. In addition, ‘isLst’ and ‘enIRQ’ fields may be set in the register bits cmd3[3:2].

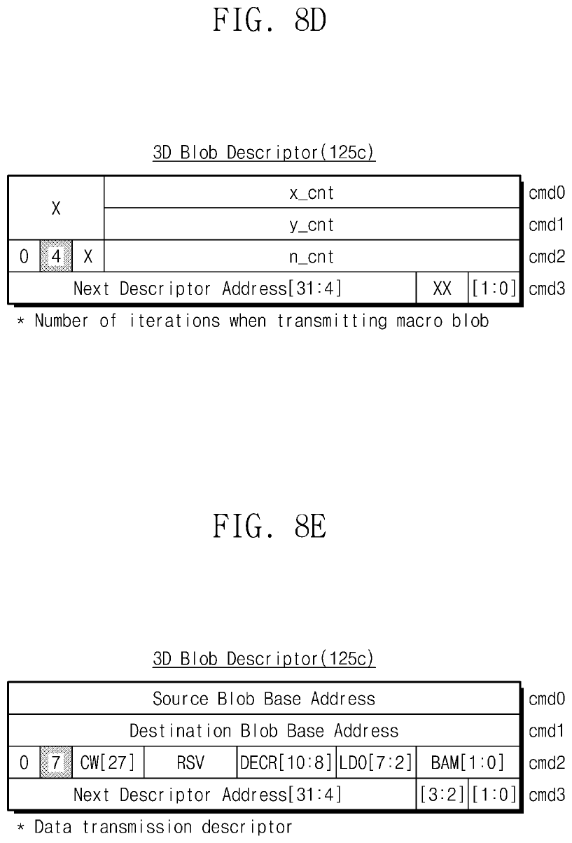

FIGS. 8A to 8E are diagrams illustrating a structure of a 3D blob descriptor. A 3D blob descriptor 125c of the present disclosure includes four command registers cmd0, cmd1, cmd2, and cmd3, and various attributions may be set according to the values of the register bits cmd2[30:28]=1,2,3,4, and 7 of the command register cmd2. As described in Table 1, the register bit cmd2[31] means a data type DTY[31] of the blob descriptor, and register bits cmd2[30:28] indicates a payload type PTY[30:28] of the blob descriptor.

FIG. 8A is a diagram illustrating a blob descriptor defining a dimension of virtual data. Referring to FIG. 8A, in the 3D blob descriptor 125c, a value of the register bits cmd2[30:28] of the command register cmd2 is set to ‘1’. In this case, the 3D blob descriptor 125c has the meaning of defining a dimension of data. In this case, in each of the command registers cmd0, cmd1, and cmd2, each specification of X (width), Y (height), and N (depth) corresponding to the specification of the three-dimension data (3D blob) stored in the memory 130 is set. Thereafter, when the 3D DMA controller 120 accesses the macro blob inside the 3D data (3D Blob), the 3D DMA controller 120 uses the X, Y, and N values to perform addressing internally in hardware.

FIG. 8B is a diagram illustrating a blob descriptor defining a position of the macro blob. Referring to FIG. 8B, in the 3D blob descriptor 125c, a value of the register bits cmd2[30:28] of the command register cmd2 is set to ‘2’. In this case, the 3D blob descriptor 125c provides a start position of the macro blob 136 inside the 3D data 135 (refer to FIG. 2).

The start position of the macro blob may be expressed as an offset value from the first data of the 3D data 135 to the first data of the macro blob 136. That is, the 3D blob descriptor 125c in which a value of the register bits cmd2[30:28] of the command register cmd2 is set to ‘2’ may define a position of the macro blob 136 in the 3D data 135. The start position of the macro blob 136 may be provided as ‘x start’, ‘y start’, and ‘n start’ in the command registers cmd0, cmd1, and cmd2, respectively.

FIG. 8C is a diagram illustrating a 3D blob descriptor defining a size of the macro blob. Referring to FIG. 8C, in the 3D blob descriptor 125c, a value of the register bits cmd2[30:28] of the command register cmd2 is set to ‘3’. In this case, the 3D blob descriptor 125c may provide a size value of the macro blob 136.

The size of the macro blob 136 corresponding to all or part of the 3D data 135 to be transmitted by the 3D DMA controller 120 may be set in the command registers cmd0, cmd1, and cmd2. That is, the size of the macro blob 136 may be provided as ‘x_size’, ‘y_size’, and ‘n_size’ in the command registers cmd0, cmd1, and cmd2, respectively.

FIG. 8D is a diagram illustrating a 3D blob descriptor defining the number of repetitions of the macro blob. Referring to FIG. 8D, in the 3D blob descriptor 125c, a value of the register bits cmd2[30:28] of the command register cmd2 is set to ‘4’. In this case, the 3D blob descriptor 125c may set the number (count of iterations) of adjacent macro blobs to be transmitted of the same specification as the macro blob 136 that have already been transmitted.

After the transmission of one macro blob 136 is completed, the 3D DMA controller 120 may repeatedly transmit adjacent macro blobs in the same specification. An iteration count in which adjacent macro blobs are repeatedly transmitted may be set in the command registers cmd0, cmd1, and cmd2. That is, the iteration count in which macro blobs are repeatedly transmitted may be provided as ‘x_cnt’, ‘y_nt’, and ‘n_cnt’ in each of the command registers cmd0, cmd1, and cmd2.

The ‘x_cnt’, ‘y_cnt’, and ‘n_cnt’ set in each of the command registers cmd0, cmd1, and cmd2 may indicate how many adjacent macro blobs of the same specification in the x, y, and n directions, respectively, to be repeatedly transmitted to the destination address.

Thereafter, the 3D DMA controller 120 sequentially transmits each macro blobs by the hardware itself according to the set values.

FIG. 8E is a diagram illustrating a 3D blob descriptor defining a data transmission. Referring to FIG. 8E, in the 3D blob descriptor 125c, a value of the register bits cmd2[30:28] of the command register cmd2 is set to ‘7’. In this case, after the 3D blob descriptor 125c is loaded, the macro blob is actually transmitted to the destination address.

That is, the setting is completed by the blob descriptors of the register bits cmd2[30:28]=0, 1, 2, 3, 4 of the command register cmd2, and then when the 3D blob descriptor 125c of the register bits cmd2[30:28]=7 sets a source address, a destination address, etc., data transmission starts. In this case, data transmission may be variously set by various field values set in the 3D blob descriptor 125c, and the contents of these fields may be represented in Table 2 below.

TABLE 2

| Field | Description |
|---|---|
| cmd2[27] | It means a constant write. When it is set, the read |
| (CW) | operation in the same way as a CW field of a Normal |
| | Descriptor is not performed, but using cmd0 as a |
| | constant value, constant value filling is performed by |
| | writing to the destination macro blob as a constant value. |
| cmd2[10:8] | Decrement index for subsequent macro blob: When |
| (DECR) | selecting the subsequent adjacent macro blob after |
| | completing one macro blob transmission, for each of the |
| | x, y, and n directions, whether to select an increasing |
| | adjacent macro blob or a decreasing adjacent macro blob |
| | is set to select. |
| | [10] = ‘1’: Transmitting the adjacent macro blob in the |
| | x-direction in increasing direction, and in case of ‘0’, |
| | transmitting the adjacent macro blob in the decreasing |
| | direction. |
| | [9]: same for y-direction |
| | [8]: same for n-direction |
| cmd2[7:2] | It means Loop Direction Order, and when transmitting |
| (LDO) | macro blobs sequentially in 3D blob, which of the x, y, |
| | and n directions is applied first is set. |
| | cmd2[3:2]: INNER (set the first progress direction among |
| | x, y, n directions) |
| | 0: N-direction, 1: Y-direction, 2: X-direction |
| | cmd2[5:4]: MIDDLE (set the progress direction following |
| | INNER among x, y, n directions) |
| | cmd2[7:6]: OUTER (set the last progress direction among |
| | x, y, n directions) |
| | For example, when INNER = 0 (N-direction)/MIDDLE = |
| | 1 (Y-direction)/OUTER = 2 (X-direction), after one macro |
| | blob is transmitted, the adjacent macro blob in |
| | N-direction selected and transmitted with reference to the |
| | DECR field. When the transmission is completed in the |
| | N-direction of the 3D blob specification, the subsequent |
| | macro blob is transmitted by moving the index referring |
| | to the DEC field in the Y-direction. After that, it moves |
| | in the X-direction to transmit macro blobs. |
| cmd2[1:0] | It means a Blob Address Mode. |
| (BAM) | [1]: Source Address Mode is set |
| | [0]: Destination Address Mode is set |
| | When the corresponding bit is ‘1’, the address is a blob |
| | address for macro blob inside 3D-Blob. |
| | When the corresponding bit is ‘0’, the address assumed |
| | to be 1D memory is output. |
| | This address generation is mainly used to convert a 3D |
| | blob into a 1D vector or convert an area stored as a 1D |
| | vector into a 3D blob. |
| cmd1[3] | It means Read Address Fixed, and it is to generate a fixed |
| (RDAfixed) | address (set to ‘1’) when reading data, or to generate a |
| | changing address created by Blob Address Mode (set |
| | to ‘0’). |
| | This method is for the case where the source side that |
| | reads data uses a single memory address value such as a |
| | FIFO format instead of a general memory. |
| cmd1[2] | It means Write Address Fixed and has the same meaning |
| (WRAfixed) | as RDAfixed, but it is a setting for address creation for |
| | the write side. |
| cmd1[1:0] | It is used in the same meaning as isLast and enIRQ of the |
| (isLast, | conventional DMAC technology. |
| enIRQ) | This is to ensure compatibility with the conventional art. |

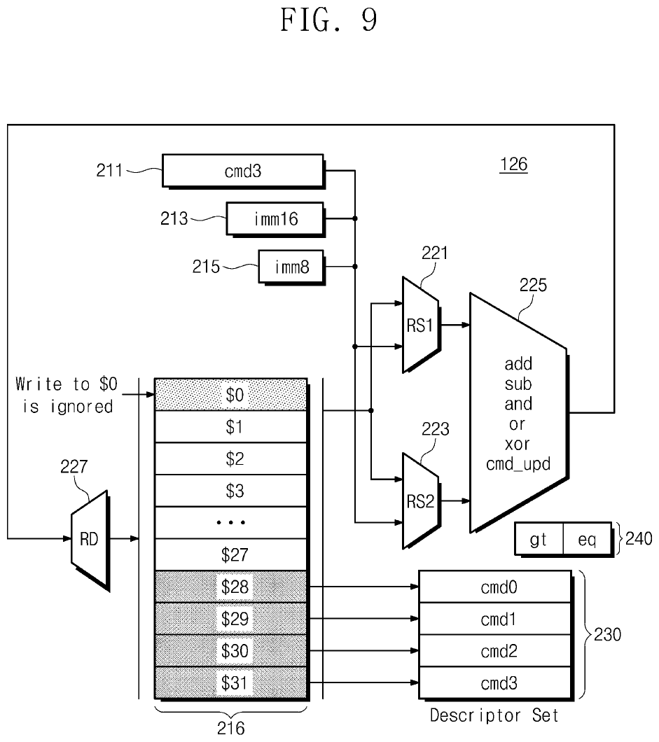

FIG. 9 is a block diagram illustrating a microcode (uCode) controller of FIG. 4. Referring to FIG. 9, the uCode controller 126 includes a general purpose register 216 composed of 32 registers. The uCode controller 126 includes an ISA (Instruction Set Architecture), which will be described later. The uCode controller 126 is a controller having a 31-bit instruction code.

The uCode controller 126 may generate a descriptor by itself by executing a program by an instruction. In addition, the generated descriptor may be transferred to the internal logic of the 3D DMA controller 120. Accordingly, the 3D DMA controller 120 may change the data movement variably and dynamically in software according to the internal state of the system.

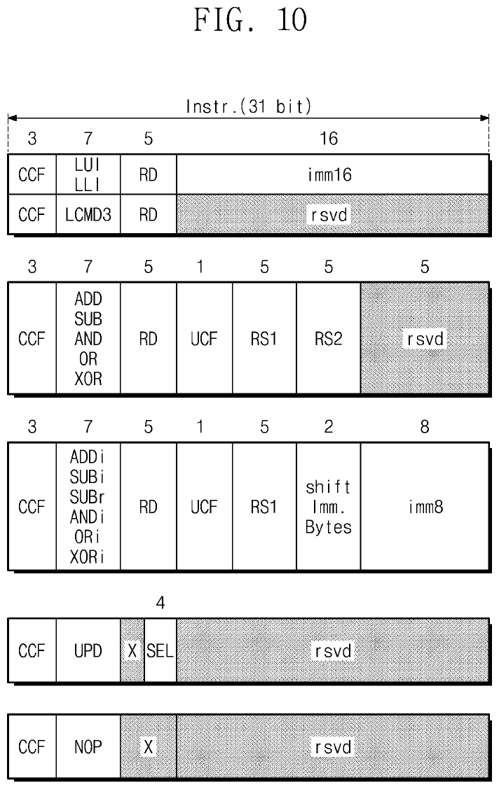

FIG. 10 is a diagram illustrating an ISA (Instruction Set Architecture) of a microcode controller of the present disclosure. Referring to FIGS. 9 and 10, an instruction set Instr. having a 31-bit width includes a bit field as described below.

RS1, RS2, and RD are fields for selecting the source register used as an input of an ALU (not illustrated) among the general purpose registers 216 (refer to FIG. 9) and the destination register for storing the result values of an operation. As illustrated in FIG. 9, a source register of a multiplexer 221 is selected by ‘RS1’, and a source register of a multiplexer 223 is selected by ‘RS2’. In addition, a destination register will be selected from among the general purpose registers 216 (refer to FIG. 9) by a demultiplexer 227 according to the ‘RD’ value.

Field values ‘imm16’ and ‘imm8’ of the instruction set Instr. mean immediate data values included in the instruction code field. The ‘imm16’ and ‘imm8’ may have a 16-bit or 8-bit size.

As described above, ‘cmd3’ includes the address of the subsequent descriptor that is stored in the previously loaded blob descriptor. The ‘cmd3’ is used to return to the conventional DMA operation after the DMA operation is changed by the uCode controller 126. That is, ‘cmd3’ corresponds to a return address in a general CPU.

A ‘shift Imm. Bytes’ field is used for an operation of shifting immediate data included in an instruction code to the left in units of 0, 8, 16, or 32-bit. However, in the case of a direct AND instruction (ANDI instruction), other parts other than ‘imm8’ data are set to ‘1’ and used for an operation. Other parts other than ‘imm8’ data of other instructions are set to ‘0’ and used for an operation.

In addition, the uCode controller 126 inside the 3D DMA controller 120 of the present disclosure has a 7-bit ‘OPCODE’ and is expandable to a maximum of 128 instructions, and a defined instruction set may be represented in Table 3 below.

TABLE 3

| Instruction | |
|---|---|
| code | Description |
| NOP | No operation |
| LLI | Load immediate field to Lower half of destination register |
| LUI | Load immediate field to Upper half of destination register |
| LCOMD3 | Load CMD3 data to destination register |
| ADD | rd = rs1 + rs2 |
| SUB | rd = rs1 − rs2 |
| AND | rd = rs1 & rs2 |
| OR | rd = rs1 \| rs2 |
| XOR | rd = rs1 \hat{ } rs2 |
| ADDI | rd = rs1 + shift(imm8) |
| SUBI | rd = rs1 − shift(imm8) |
| SBUR | rd = shift(imm8) − rs1 |
| ANDI | rd = rs1 & shift(imm8).setOtherBits |
| ORI | rd = rs1 \| shift(imm8).clrOtherBits |
| XORI | rd = rs1 \hat{ } shift(imm8) |
| UPD | Copy R28 to CMD0 if SEL[0] = 1 otherwise do not copy |
| | Copy R29 to CMD1 if SEL[1] = 1 otherwise do not copy |
| | Copy R30 to CMD2 if SEL[2] = 1 otherwise do not copy |
| | Copy R31 to CMD3 if SEL[3] = 1 otherwise do not copy |
| | After copy, execute the descriptor |
| | {CMD3, CMD2, CMD1, CMD0} |

In the case of the instruction in which an ‘Update Condition Flag (UCF)’ field is set to ‘1’, the uCode controller 126 checks the operation result and sets an ‘eq’ flag when the operation result is ‘0’ to set state ‘1’, otherwise the uCode controller 126 sets the ‘eq’ flag to a clear state ‘0’. When the operation result of the instruction is checked and the operation result is positive, the uCode controller 126 sets a ‘gt’ flag to the set state ‘1’, otherwise sets the ‘gt’ flag to the clear state ‘0’. With respect to an instruction in which the ‘UCF’ field is not set or the ‘UCF’ field does not exist, the uCode controller 126 does not change the condition flags (eq, gt, and condition flag) even after the operation is performed.

A ‘CCF (Condition Code Flag)’ field is set by referring to the output result of ‘gt (greater than)’ and ‘eq (equal)’ that are updated for every result of every operation by an instruction set in which ‘Update Condition Flag (UCF)’ is set to the set state ‘1’. When the condition corresponding to the ‘CCF’ field is satisfied, the corresponding instruction is executed, otherwise, the corresponding instruction is ignored. Table 4 below represents execution conditions of instructions according to the used CCF.

TABLE 4

| | |
|---|---|
| \grave{ }define CCF_TRUE ′h0 | // run always |
| \grave{ }define CCF_IFEQ ′h1 | // run if eq |
| \grave{ }define CCF_IFNE ′h2 | // run if ne |
| \grave{ }define CCF_IFGT ′h3 | // run if gt |
| \grave{ }define CCF_IFLT ′h4 | // run if lt |
| \grave{ }define CCF_IFGE ′h5 | // run if ge |
| \grave{ }define CCF_IFLE ′h6 | // run if le |

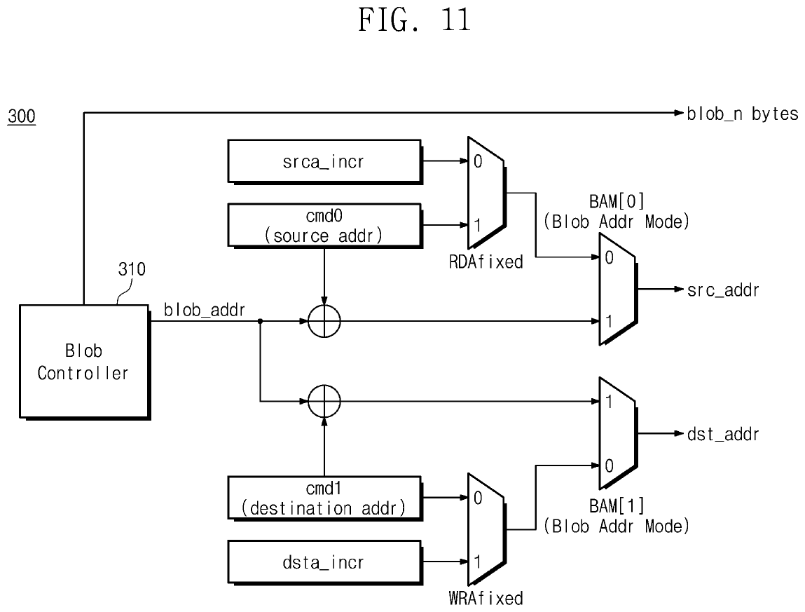

FIG. 11 is a diagram schematically illustrating an address generation method according to an embodiment of the present disclosure. Referring to FIG. 11, an address generator 300 may use the address (blob_addr) of a blob controller 310, and the source address (source addr) and destination address (destination addr) provided from the descriptor to actually generate the address (src_ddr, dst_addr) of the memory 130.

According to an embodiment of the present disclosure, a DMA controller that accesses 3D or multi-dimension data may provide high performance by removing inefficiencies that occur when sequentially accessing multi-dimension data.

While the present disclosure has been described with reference to embodiments thereof, it will be apparent to those of ordinary skill in the art that various changes and modifications may be made thereto without departing from the spirit and scope of the present disclosure as set forth in the following claims.

What is claimed is:

1. A multi-dimension DMA controller for performing a direct memory access (DMA) of multi-dimension data stored in a memory, comprising:
a descriptor including a microcode descriptor, a normal descriptor, and a three-dimensional (3D) blob descriptor for accessing the multi-dimension data;
a microcode controller configured to execute an instruction included in the microcode descriptor; and
a transmission controller configured to automatically transmit at least a portion of the multi-dimension data depending on a parameter stored in the descriptor.

2. The multi-dimension DMA controller of claim 1, wherein the microcode descriptor includes a plurality of command registers, and
wherein an instruction is stored in first to third command registers among the plurality of command registers, and a subsequent descriptor address is stored in a fourth register among the plurality of command registers stores.

3. The multi-dimension DMA controller of claim 2, wherein at least one bit of the third command register includes a data type field indicating whether the multi-dimension data is a one-dimensional array or a multi-dimensional array.

4. The multi-dimension DMA controller of claim 1, wherein the normal descriptor includes a first command register for storing a source address, a second command register for storing a destination address, and a third command register for storing the number of transmission bytes, and
wherein the third command register includes a constant write (CW) field defining an attribution of the source address.

5. The multi-dimension DMA controller of claim 4, wherein, when the constant write (CW) field is logical ‘1’, a field corresponding to the source address of the first command register indicates constant data.

6. The multi-dimension DMA controller of claim 5, wherein, when the constant write (CW) field is logical ‘1’, the multi-dimension DMA controller writes the constant data corresponding to the number of transmission bytes to the destination address of the memory without performing a read operation.

7. The multi-dimension DMA controller of claim 1, wherein the 3D blob descriptor includes first to third command registers for storing payload data, and a fourth command register for storing an address of a subsequent descriptor, and
wherein the third command register includes a payload type field indicating an attribution of the payload data.

8. The multi-dimension DMA controller of claim 7, wherein, when the payload type field is a first value, the payload data defines a specification of 3D data in the memory.

9. The multi-dimension DMA controller of claim 7, wherein, when the payload type field is a second value, the payload data defines a position of a macro blob included in 3D data in the memory.

10. The multi-dimension DMA controller of claim 7, wherein, when the payload type field is a third value, the payload data defines a size of a macro blob included in 3D data in the memory.

11. The multi-dimension DMA controller of claim 7, wherein, when the payload type field is a fourth value, the payload data correspond to data for transmitting at least one adjacent macro blob having the same specification as a previously transmitted macro blob.

12. The multi-dimension DMA controller of claim 11, wherein the payload data includes at least one of an iteration count of the at least one adjacent macro blob, and a direction of the at least one adjacent macro blob relative to the previously transmitted macro blob within the multi-dimension data.

13. The multi-dimension DMA controller of claim 12, wherein the payload data includes a field configured to convert an address of the at least one adjacent macro blob into a multi-dimensional array or a one-dimensional array.

14. The multi-dimension DMA controller of claim 12, wherein the payload data includes a field indicating whether to generate a fixed address or a variable address.

15. The multi-dimension DMA controller of claim 14, wherein the fixed address corresponds to a case in which the source address of the descriptor is a first-in-first-out (FIFO) memory.

16. The multi-dimension DMA controller of claim 1, wherein the microcode controller has 32 general purpose registers and 31 instruction codes.

17. The multi-dimension DMA controller of claim 16, wherein the microcode controller includes a source register (RS) used as an input of an ALU of the microcode controller among the general registers, and a destination register (RD) for storing a processing result of the ALU.

18. A computer system comprising:
a central processing unit;
a memory device; and
a multi-dimension DMA controller configured to perform a direct memory access (DMA) of multi-dimension data stored in the memory device under a control of the central processing unit, and
wherein the multi-dimension DMA controller includes:
a descriptor including a microcode descriptor, a normal descriptor, and a three-dimensional (3D) blob descriptor for accessing the multi-dimension data;
a microcode controller configured to execute an instruction included in the microcode descriptor; and
a transmission controller configured to automatically transmit at least a portion of the multi-dimension data depending on a parameter stored in the descriptor.

19. The computer system of claim 18, wherein the 3D blob descriptor includes first to third command registers for storing payload data, and a fourth command register for storing an address of a subsequent descriptor, and the third command register includes a payload type field indicating an attribution of the payload data.
